(19) United States
(12) Patent Application Publication
(10) Pub. No.: US 2007/0044370 A1
(43) Pub. Date: Mar. 1, 2007

(54) Coil, coil module and method of manufacturing the same, current sensor and method of manufacturing the same

(75) Inventor: Shigeru Shoji, Tokyo (JP)

Correspondence Address: OLIFF & BERRIDGE, PLC, P.O. BOX 19928, ALEXANDRIA, VA, 22320, US

(73) Assignee: TDK CORPORATION, Tokyo (JP)

(21) Appl. No.: 11/511,456

(22) Filed: Aug. 29, 2006

(30) Foreign Application Priority Data
Aug. 31, 2005 (JP) 2005-252805

(51) Int. Cl. A01K 91/00

(52) U.S. Cl. 43/44.98

(57) ABSTRACT

The current sensor includes: a housing having a base and a lid; and a coil housed in a recess of the base, having winding section consisting of straight-line portions and semicircle portions and lead sections. The lead section includes a straight leader extending continuously from the straight-line portion on the extension thereof, and the semicircle portions are wound so as to climb over the straight leader but are wound in the same layer as the winding section in an area other than that corresponding to the straight leader. For this reason, distribution of the current magnetic fields generated by the coil will become comparatively uniform as a whole. Consequently, current magnetic fields which are sufficiently stabilized current magnetic fields can be applied to a magnetic sensor can be supplied in a uniform direction.

### BACKGROUND OF THE INVENTION

1. Field of the Invention

The present invention relates to a coil which generates current magnetic fields by supplying current, a coil module provided with the coil and method of manufacturing the same, a current sensor provided with the coil and method of manufacturing the same.

2. Description of the Related Art

In order to accurately detect small control current flowing in a circuit of a control device, a method of connecting resistors in series in the circuit and measuring a voltage drop in the resistors is used in general. In this case, however, a load different from that in a control system is applied, and there is a possibility that an adverse influence may be exerted on the control system. In order to prevent such problem, method of indirectly measuring control current by detecting the gradient of a current magnetic field generated by the control current has used. Specifically, the method is that, for example, a Wheatstone bridge is formed using four Giant Magneto-Resistive effect elements (hereinafter referred to as GMR elements) which develop a Giant Magneto-Resistive effect and at the same time a conductor (bus bar) of the shape of straight-line or of the shape of a U-type is provided in the vicinity of the four GMR elements. Then, current magnetic fields are generated by introducing the above-mentioned control current to the straight-line/U-type conductor (bus bar). The gradient of the current magnetic fields is detected by the difference of the resistance of each GMR elements (for example, refer to Patent Document of U.S. Pat. No. 5,621,377 description).

### SUMMARY OF THE INVENTION

However, in the case of measuring a weak current which is less than 10 A for example, it often happens that only the current magnetic fields generated from one conductor is not adequate even with a current sensor using GMR elements. In that case, a method of using a coil that is wound multiple-times in the same layer as a bus bar can be considered. However, compared with the straight-line/U-type bus bars, the distribution of magnetic fields generated by such a coil has a large dispersion, and it has been unsuitable for measuring weaker current with sufficient precision.

It is desirable to provide a current sensor capable of measuring a current to be detected with high precision and stability while realizing a compact configuration using the current magnetic fields generated by the current to be detected, to provide a coil and a coil module suitable for being loaded in such a current sensor. Also it is desirable to provide a method of manufacturing the above-described current sensor and a method of manufacturing the above-mentioned coil module.

The coil of an embodiment of the present invention is made of a wire, having a winding section constructed of a plurality of turns of the wire, each turn having a straight-line portion and a semicircle portion, and a lead section having a straight leader which leads a straight-line portion of an innermost turn in the winding section to outside, the straight leader extending continuously from the straight-line portion on the extension thereof. Each semicircle portion is located in a layer other than a layer of the straight-line portion, climbing across the straight leader, in an area of the straight leader, while is located in a layer same as the layer of the straight-line portion, in an area other than the straight leader.

More specifically, each semicircle portion is located in the same layer as the layer to which the straight-line portion belongs, in a whole or partial area other than an area corresponding to the straight leader.

A coil module of an embodiment of the present invention includes a base, a lid, and a coil made of a wire, the coil including: a winding section housed in a space produced when the base and the lid are combined each other, the winding section constructed of a plurality of turns of the wire, each turn having a straight-line portion and a semicircle portion; and a lead section having a straight leader which leads a straight-line portion of an innermost turn in the winding section to outside, the straight leader extending continuously from the straight-line portion on the extension thereof. Each semicircle portion is located in a layer other than a layer of the straight-line portion, climbing across the straight leader, in an area of the straight leader, while is located in a layer same as the layer of the straight-line portion, in an area other than the straight leader.

In the coil or the coil module, the straight leader continuously extends from the straight-line portion of the innermost turn on the extension thereof, and the semicircle portions climb over the straight leader, while they are wound so as to be located in the same layer as the innermost turn in an area other than the straight leader. Therefore, a current magnetic field in the straight-line portion of the innermost turn, which is generated when current flows through, comes to be hardly subject to the influence by a current magnetic field generated in the straight leader. In the coil or the coil module of the present invention, it is particularly preferable that the plurality of turns in the winding section are wound in such a manner that at least the straight-line portions adjacent to each other are in contact with each other.

A current sensor of an embodiment of the present invention has a base, a lid, a coil made of a wire and one or more magnetic sensors provided in correspondence with the straight-line portions of the winding section. The coil includes: a winding section housed in a space produced when the base and the lid are combined each other, the winding section constructed of a plurality of turns of the wire, each turn having a straight-line portion and a semicircle portion; and a lead section having a straight leader which leads a straight-line portion of an innermost turn in the winding section to outside, the straight leader extending continuously from the straight-line portion on the extension thereof. Each semicircle portion is located in a layer other than a layer of the straight-line portion, climbing across the straight leader, in an area of the straight leader, while is located in a layer same as the layer of the straight-line portion, in an area other than the straight leader.

In the current sensor, the straight leader continuously extends from the straight-line portion of the innermost turn on the extension thereof, and the semicircle portions climb over the straight leader while they are wound so as to be located in the same layer as the innermost turn in an area other than the straight leader. Therefore, a current magnetic field in the straight-line portion of the innermost turn, which is generated when current flows through the coil, comes to be hardly subject to the influence by a current magnetic field generated in the straight leader. For this reason, current magnetic fields can be applied to the magnetic sensor in a uniform direction.

A method of manufacturing a coil module of an embodiment of the present invention includes steps of: preparing a base having a pillar-shaped core and winding a wire around the core, thereby forming a coil, the coil including a winding section constructed of a plurality of turns of the wire, each turn having a straight-line portion and a semicircle portion, and a lead section having a straight leader which leads a straight-line portion of an innermost turn in the winding section to outside; putting a lid on the base so as to face each other with the coil in between; and fixing the winding section to the base with adhesives. In the step of forming the coil, the lead section is formed so as to include a straight leader extending continuously from the straight-line portion on the extension thereof; and each semicircle portion is formed in a layer other than a layer of the straight-line portion, climbing across the straight leader, in an area of the straight leader, while is located in a layer same as the layer of the straight-line portion, in an area other than the straight leader.

A method of manufacturing a current sensor of an embodiment of the present invention includes steps of: preparing a base having a pillar-shaped core and winding a wire around the core, thereby forming a coil, the coil including a winding section constructed of a plurality of turns of the wire, each turn having a straight-line portion and a semicircle portion, and a lead section having a straight leader which leads a straight-line portion of an innermost turn in the winding section to outside; putting a lid on the base so as to face each other with the coil in between; fixing the winding section to the base with adhesives; and providing one or more magnetic sensors in correspondence with the straight-line portions of the winding section. In the step of forming the coil, the lead section is formed so as to include a straight leader extending continuously from the straight-line portion on the extension thereof; and each semicircle portion is formed in a layer other than a layer of the straight-line portion, climbing across the straight leader, in an area of the straight leader, while is located in a layer same as the layer of the straight-line portion, in an area other than the straight leader.

In the methods of manufacturing the coil module and the current sensor, the lead section is formed so as to include the straight leader extending continuously from the straight-line portion of the innermost turn on the extension thereof, and the semicircle portions are formed so as to climb over the straight leader while they are located in the same layer as the innermost turn in an area other than the straight leader. Thereby, current magnetic fields in the straight-line portion of the innermost turn, generated when current is flown through the coil, come to be hardly subject to the influence by the current magnetic fields generated in the straight leader.

According to the coil, coil module or the current sensor, the lead section includes the straight leader extending continuously from the straight-line portion of the innermost turn on the extension thereof, and the semicircle portions are wound so as to climb over the straight leader while they are located in the same layer as the innermost turn in an area other than the straight leader. Therefore, the intensity and the direction of the current magnetic fields which are generated in the straight-line portion of the innermost turn are comparatively stabilized. For this reason, distribution of the current magnetic fields generated by the whole coil will become comparatively uniform. Especially, since the magnetic sensor is provided in the position corresponding to the straight-line portions of the winding section, the current magnetic fields can be applied to the magnetic sensor in a uniform direction, and detection with high precision is consequently allowed even with weak currents. According to the methods of manufacturing the coil module or the current sensor, coil modules or current sensors of high quality as in the above can be manufactured comparatively simply and with high precision.

### BRIEF DESCRIPTION OF THE DRAWINGS

FIG. 1A is a plan view and FIG. 1B is a cross sectional view, showing the configuration of a current sensor according to one embodiment of the present invention.

FIG. 2A is a plan view and FIG. 2B is a cross sectional view, showing the configuration of a base in the current sensor appearing in FIG. 1A and FIG. 1B, respectively.

FIG. 3A is a plan view and FIG. 3B is a cross sectional view, showing the configuration of a coil in the current sensor appearing in FIG. 1A and FIG. 1B, respectively.

FIG. 4A is a plan view and FIG. 4B is a cross sectional view, showing the configuration of a lid in the current sensor appearing in FIG. 1A and FIG. 1B, respectively.

FIG. 5 is a circuit diagram corresponding to the current sensor illustrated in FIG. 1A and FIG. 1B.

FIG. 6 is a plan view showing the configuration of a modified example of the base shown in FIG. 2A and FIG. 2B.

FIG. 7 is a plan view showing the configuration of a modified example in the current sensor according to the one embodiment of the present invention.

FIG. 8 is a circuit diagram corresponding to the current sensor of the modified example illustrated in FIG. 7.

### DETAILED DESCRIPTION OF THE PREFERRED EMBODIMENTS

An embodiment of the invention will be described in detail hereinafter with reference to the drawings.

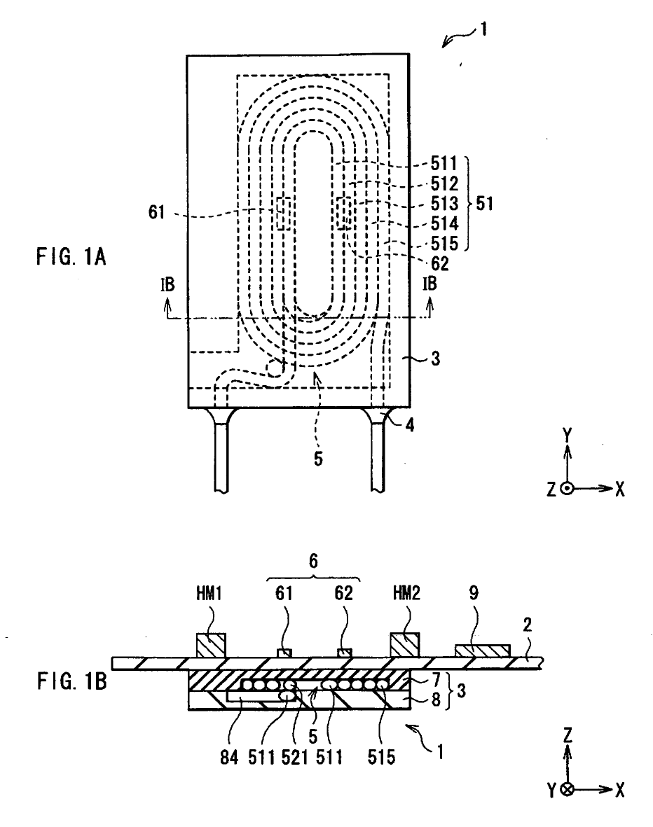

First, the configuration of a current sensor as one embodiment of the present invention will be described with reference to FIGS. 1A to 6. FIG. 1A and FIG. 1B show a configuration of the current sensor according to the present embodiment provided with a coil module 1 and a magnetic sensor 6. FIG. 1A is a plan view, and FIG. 1B is a cross sectional view taken along line IB-IB of the current sensor illustrated in FIG. 1A seen from the direction indicated by the arrows. However, FIG. 1A shows only the configurations of the coil module 1 and the magnetic sensor 6 for simplification.

The current sensor has: a housing 3 fixed to a supporting board 2; a coil 5 housed windingly in the inside of the housing 3 so that the both ends of the coil 5 are pulled out from the housing 3 to be fixed respectively by a jointing 4; and a magnetic sensor 6 including GMR elements 61, 62 provided on the supporting board 2 on the side opposite to the housing 3. Herein, the housing 3 and the coil 5 construct the coil module 1. The housing 3 is approximately forming a shape of rectangular parallelepiped, with a dimension in the X-axis direction of about 10 mm and a dimension in the Y-axis directions of about 20 mm and a dimension in the Z-axis direction of about 1 mm, for example. The housing 3 is formed by two members of a base 7 and a lid 8, the base 7 being fixed so as to touch the supporting board 2. The coil 5 has a plurality of winding parts 51 (511 to 515) that is winding the circumference of a core 72 (which will be described later), and lead sections 52 and 53 (which will be described later) from an innermost circumference 511 of the winding parts 51 and an outermost circumference 515 of the winding part 51, respectively. The supporting board 2 further has permanent magnets HM1, HM2 applying a bias magnetic field to the GMR elements 61, 62, and a detection circuit 9 including constant current sources 91 and 92 (which will be described later), etc.

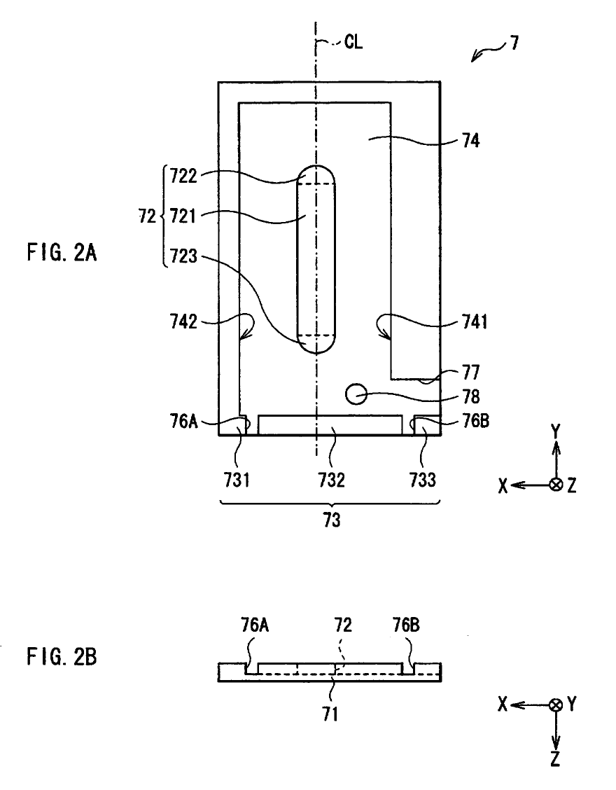

FIG. 2A and FIG. 2B show the configuration of the base 7 in the housing 3: FIG. 2A is a plan view thereof, and FIG. 2B is a cross sectional view. The base 7 is constructed so as to have the core 72 on a substrate 71 that has a thickness of 0.35 mm, for example. The core 72 has the shape of a plan type made of a rectangle portion 721 with the long arms of 7.5 mm and the short arms of 1.8 mm, and two semicircular parts 722, 723 with the radius of 0.9 mm combined together. Herein, the two semicircular parts 722, 723 are arranged so that the diameter portions thereof may touch the short arms of the rectangle portion 721 respectively. The core 72 has a width corresponding to the diameter of an enamel-covered conductor (which will be described later) that forms the coil 5 (for example, 0.55 mm). Beside, the base 7 has an outer wall group 73 consisting of outer walls 731-733 set up on the substrate 71 along the outer edge of the substrate 71, thereby capable of forming a recess 74. The recess 74 has a depth equivalent to the diameter of the coil 5 (for example, 0.55 mm). The recess 74 is a space for housing the winding part 51 (which will be described later) of the coil 5. An in-wall plane 741 and an in-wall plane 742 in the recess 74 are arranged in the equal distance mutually from a central line CL, which passes through the center position of the core 72 (center position of the rectangle portion 721 in the short side direction thereof), and are in parallel with the central line CL as well. Namely, the in-wall plane 741 and the in-wall plane 742 are arranged in parallel with the long arms of the rectangle portion 721 respectively, facing oppositely each other. There is a space for, for example, five turns between the core 72 and the in-wall plane 741, and between the core 72 and the in-wall plane 742, respectively. The base 7 further has cutout sections 76A, 76B for pulling out the ends of the coil 5 outside the housing. The base 7 further has a drain 77 for discharging surplus adhesives used in order to fix the coil 5 onto the recess 74 in manufacturing the coil module 1. A pin 78 has a function of supporting the coil 5 in the winding operation of the coil 5.

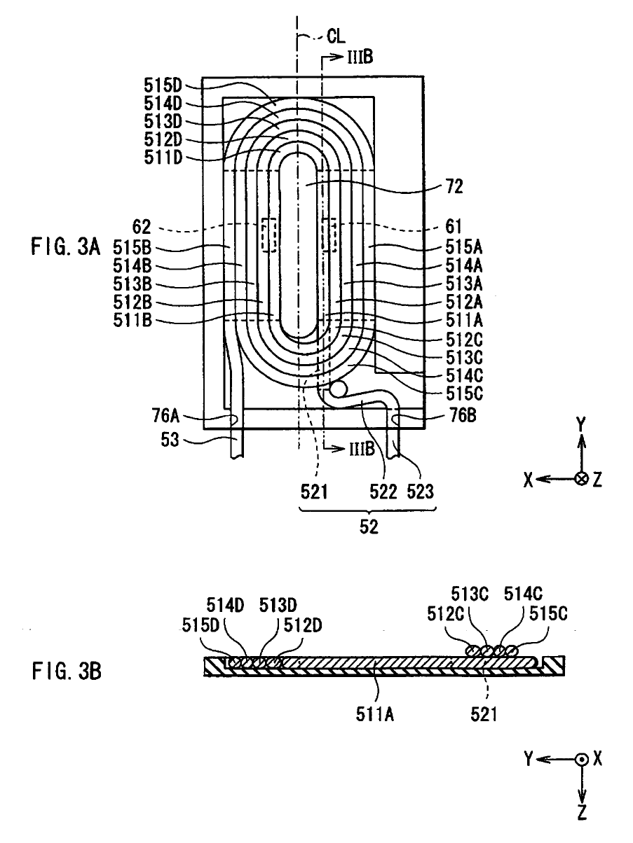

FIG. 3A expresses a plan view of the coil 5 housed in the recess 74 of the base 7, and FIG. 3B expresses a cross sectional view of the coil 5 taken along line IIIB-IIIB shown in FIG. 3A seen from the direction indicated by the arrows. The coil 5 is made of an enamel-covered conductor (hereinafter referred to as wire) with a diameter of 0.55 mm for example, and has a plurality of winding parts 51 (511-515) winding the circumference of the core 72 and lead sections 52, 53 as described above. The winding parts 51 has straight-line portions 511A-515A and straight-line portions 511B-515B which are extending in parallel each other, arranged separately to be faced each other, with a predetermined space corresponding to the width in the X-axis direction of the core 72, and semicircle portions 512C-515C and semicircle portions 511D-515D for linking the straight-line portions respectively.

The lead section 52 has a straight leader 521 extending continuously from the straight-line portion 511A on the extension thereof, a crooked part 522 and a straight-line portion 523 extending continuously from the straight leader 521 in this order. The straight-line portion 523 is pulled out through the cutout section 76B of the base 7 to go outside. The winding part 511 and the straight leader 521 are disposed at the same level so that they may touch the face of the substrate 71 (base of the recess 74).

The straight-line portions 511A-515A and straight-line portions 511B-515B are arranged densely, each adjoining part mutually touching densely without leaving any space therebetween. Straight-line portions 515A and 515B in the outermost winding part 515 touch closely with the in-wall planes 741, 742, respectively. Furthermore, the semicircle portions 512C-515C are wound so as to climb over the straight-line portion 521 of the lead section 52. However, in the area other than that corresponding to the straight-line portion 521, the semicircle portions 512C-515C are winding on the face of the substrate 71 so that they may be arranged in the same layer as the innermost winding part 511.

The outermost straight-line portion 515B is connected with the lead section 53 which has been pulled out through the cutout section 76A of the base 7 to go outside.

The GMR elements 61, 62 are arranged in the position corresponding to the straight-line portions 511A-515A or straight-line portions 511B-515B respectively, as shown by the broken lines appearing in FIG. 3A. In this case, it is desirable that the GMR elements 61, 62 are arranged in the equidistant position from the central line CL each other.

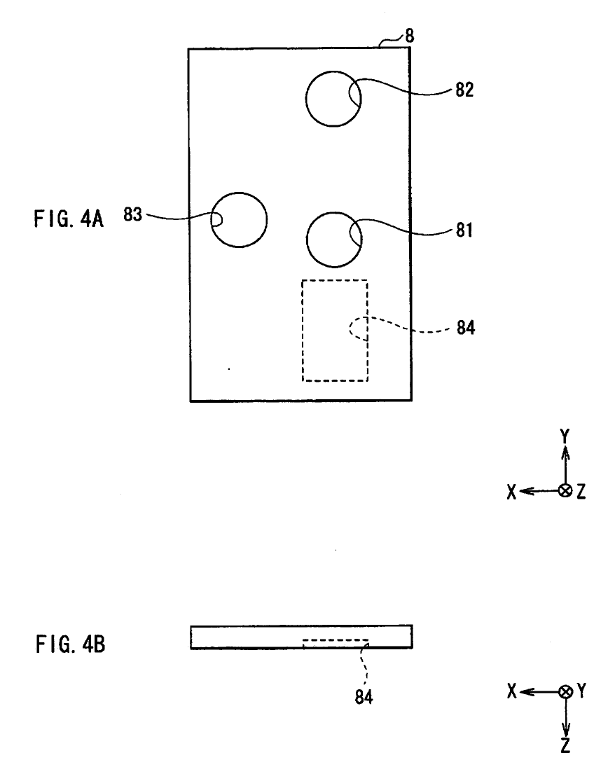

FIG. 4A and FIG. 4B express the configuration of the lid 8: FIG. 4A is a plan view and FIG. 4B is a cross sectional view thereof. The lid 8 is a parallel plate with a thickness of 1.1 mm, for example, having openings 81-83. In manufacturing the coil module 1, the openings 81-83 are used for applying the adhesives to be used for fixing the coil 5 onto the recess 73, for using a fixture or something therethrough in order to press the coil 5 against the base 7 until the adhesives are hardened, or for confirming that the winding parts of the coil 5 are not crossed each other or not bent by means of visual observation or the like therethrough. The openings 81-83 have a diameter of the order of 2-3 mm, for example. The lid 8 further has a recess 84 in the position corresponding to the area where the winding parts 512-515 climb over the straight leader 521. The recess 84 has the depth equivalent to the diameter of the wire. Thereby, when the lid 8 is put on, the coil 5 housed in the recess 74 of the base 7 can be stabilized inside the housing 3.

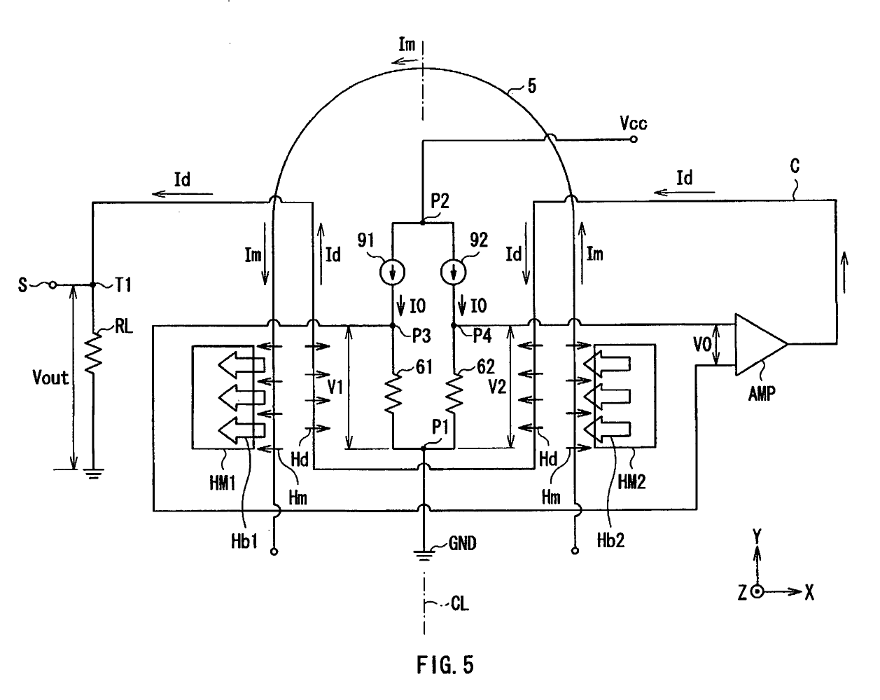

The current sensor of such configuration measures current Im to be detected that is supplied to the coil 5 with using the magnetic sensor 6. FIG. 5 shows a circuit configuration of the current sensor according to the present embodiment. It is to be noted that the coil 5 is illustrated as a shape of U-type for simplification. Also in FIG. 5, directions of all the arrows of current Im to be detected, compensating current Id, current magnetic field Hm, compensating current magnetic field Hd, bias magnetic fields Hb1, Hb2 and current I0 indicate the relative directions to the GMR elements 61, 62, respectively.

As shown in FIG. 5, the GMR elements 61 and the GMR elements 62 are connected each other at a first junction point P1. Since the GMR elements 61, 62 are arranged in the equidistant position from the central line CL, the current magnetic field Hm produced by the current Im to be detected will be applied on the GMR element 61, 62 with an equivalent magnitude. Specifically, the current magnetic field Hm will be applied on the GMR element 61 in the direction of −X, while the current magnetic field Hm will be applied on the GMR element 62 in the direction of +X. Therefore, the resistance R1 of the GMR element 61 changes in a direction opposite to a direction of a change of the resistance R2 of the GMR element 62 in accordance with the current magnetic field Hm when the current sensor is driven.

The detection circuit 9 includes a constant current sources 91, 92, one ends thereof are mutually connected at a second junction point P2. The constant current source 91 is connected with the end of the GMR element 61 on the side opposite to the first junction point P1 at a third junction point P3, while the constant current source 92 is connected with the end of the GMR element 62 on the side opposite to the first junction point P1 at a fourth junction point P4. More specifically, the GMR element 61 and the constant current source 91 are connected in series while the GMR element 62 and the constant current source 92 are connected in series, and both of the series connections are then connected in parallel each other. Herein, the constant current source 91 and the constant current source 92 are made so that a constant current I0 of a common value may be supplied to the GMR element 61 and the GMR element 62, respectively.

Permanent magnets HM1, HM2 are arranged so that they may face each other sandwiching the GMR elements 62, 62 (on the supporting board 2).

Hereafter, a method of measuring the current magnetic field Hm generated by the current Im to be detected will be explained with reference to FIG. 5.

In FIG. 5, constant currents, supplied from the constant current sources 91, 92 when a predetermined voltage is applied across the first and second junction points P1, P2, are expressed as I0 and the resistance values of the GMR elements 61, 62 are expressed as R1, R2, respectively. When the current magnetic field Hm is not applied, a potential V1 at the third junction point P3 is expressed as follows:
V1=I0*R1
and a potential V2 at the fourth junction point P4 is expressed as follows:
V2=I0*R2
Therefore, the potential difference between the third and fourth junction points P3 and P4 is expressed by the following Equation.
V0=V1−V2=I0*R1−I0*R2=I0*(R1−R2) (1)

In this circuit, when the current magnetic field Hm are applied, the amount of resistance change can be obtained by measuring the potential difference V0. For example, supposing resistance R1 and R2 increase by variations ΔR1 and ΔR2 respectively when the current magnetic field Hm are applied, an expression (1) is re-expressed as follows:

$$\begin{matrix}V 0 = V 1 - V 2 \\ = I 0 * ( R 1 - R 2 ) \\ = I 0 * \{ ( R 1 + Δ R 1 ) - ( R 2 + Δ R 2 ) \}\end{matrix} \qquad ( 2 )$$

As already stated, since the GMR elements 61, 62 are arranged so that each resistance R1 and R2 thereof may exhibit an opposite-directional change each other, in accordance with the current magnetic field Hm, values of the variation ΔR1 and variation ΔR2 exhibit an opposite positive/negative sign each other. Therefore, in Equation (2), while R1 and R2 (resistance values before application of the current magnetic field Hm) cancel out each other, the values of the variation ΔR1 and ΔR2 are maintained as they are.

Suppose that both of the GMR elements 61 and 62 have the completely same characteristics, that is, letting R1=R2=R and ΔR1=−ΔR2=ΔR), Equation (2) is re-expressed as follows:

$$\begin{matrix}V 0 = I 0 * ( R 1 + Δ R 1 - R 2 - Δ R 2 ) \\ = I 0 * ( R + Δ R - R + Δ R ) \\ = I 0 * ( 2 Δ R )\end{matrix} \qquad ( 3 )$$

Therefore, by using the GMR elements 61, 62 in which the relation between an external magnetic field and a resistance variation is grasped in advance, the magnitudes of the current magnetic field Hm can be measured, and consequently the magnitude of the current Im to be detected, which generates the current magnetic field Hm of which magnitude has been measured, can be estimated. In this case, since sensing is performed using two GMR elements 61 and 62, twice resistance variation can be taken out, compared with the case where sensing is performed using only one of the GMR elements 61, 62 independently, and consequently it becomes advantageous for more accurate measurement. Further, since dispersion in the characteristics of the GMR elements, dispersion of connection resistance, etc. can be suppressed to lower level, compared with the case where sensing is performed by forming a bridge circuit using four GMR elements, balance adjustment is made easy even when the GMR elements with high sensitivity are used. Since the number of the GMR elements themselves can be reduced and consequently the number of terminals also becomes fewer, it becomes advantageous for space-saving.

Further in the current sensor, a compensating current Id is outputted, in which the potential V1 at the third junction point P3 and the potential V2 at the fourth junction point P4 are supplied to a differential amplifier AMP and the difference therebetween (potential difference V0) serves as zero. The compensating current Id from the differential amplifier AMP produces a compensating current magnetic field Hd that extends to a direction opposite to the current magnetic field Hm by flowing in the vicinity of the GMR elements 61 and 62 in the direction opposite to the current Im to be detected. In this manner, it works so that the errors resulting from dispersion in the connection resistance in the circuit, dispersion of the mutual characteristics between the GMR elements 61, 62, the deviation of temperature distribution, or disturbance magnetic fields from the outside may be canceled. As a result of that, the detected values will be approached to the magnitude which is proportional only to that of the current magnetic field Hm. Therefore, by measuring an output voltage Vout and computing the value of the compensating current Id in view of the relation with a known resistor RL in a compensating current detection means S, the current magnetic field Hm can be calculated with more precision and the magnitude of the current Im to be detected can be estimated with high precision as a result.

Subsequently, a method of manufacturing the current sensor according to the present embodiment will be explained.

First, the base 7 having the configuration of FIGS. 2A and 2B is prepared, and the coil 5 is formed by winding a wire. As specifically shown in FIG. 3A, the wire is first passed through the cutout section 76B, then passed through between the outer wall 732 and the pin 78, and then wound around the outer circumference of the core 72. In this manner, the lead section 52 and the following innermost winding part 511 are formed. Other winding parts 512-515 are formed successively by winding the wire along with the outer edge of the above-described innermost winding part 511. And finally, the wire is pulled out through the cutout section 76A to the exterior. It is to be noted that, during the operation, the other winding parts 512-515 is wound so as to climb over the straight leader 521.

After forming the coil 5, adhesives are dropped at the winding parts 511-515, and the lid 8 is put over. Then, the winding parts 511-515 are pressed against the base 7 with a predetermined fixture through the openings 81-83 until the adhesives are hardened, and consequently the winding parts 511-515 and the base 7 are fixed together. Surplus adhesives are discharged through the drain 77 at this time. Then, the lead sections 52 and 53 are fixed onto the base 7 in the cutout sections 76A and 76B with the adhesives, and the coil module 1 is completed.

Finally, after providing the magnetic sensor 6, the permanent magnets HM1, HM2 and the detection circuit 9, etc. upon a predetermined position on one side of the supporting board 2, the coil module 1 is fixed with adhesives on the other side of the supporting board 2. At this time, the arranged positions of the GMR elements 61, 62 should be adjusted so as to correspond to the straight-line portions 511A-515A, 511B-515B, respectively. In accordance with the above-described operation, the current sensor of the present embodiment is completed.

As explained above, according to the current sensor of the present embodiment, the lead section 52 includes the straight leader 521 which is continuously linked with the straight-line portion 511A (the innermost circumference portion), extending therefrom. The semicircle portions 512C-515C are wound so as to climb over the straight-line portion 521 while the semicircle portions 512C-515C are wound in the same layer as the innermost winding part 511 in the other area than that corresponding to the straight leader 521. As a result, when the current Im to be detected is flown through the coil 5, the current magnetic fields generated from the straight-line portion 511A is hardly subject to the influence by current magnetic fields generated from the straight leader 521. In short, the intensity and the direction of the current magnetic fields which are generated in the straight-line portion 511A are comparatively stable. For this reason, distribution of the current magnetic fields generated by the coil 5 on the whole will become comparatively uniform. Thereby, it is made possible to provide the GMR element 61 arranged corresponding to the straight-line portions 511A-515A and the GMR element 62 arranged corresponding to the straight-line portions 511B-515B with stable current magnetic fields respectively, of which magnitudes are equal and of which directions are opposite to each other. As a result, detection with high precision becomes possible even in the case of weak currents. According to the method of manufacturing the current sensor of the present embodiment, current sensors of high quality as described above can be manufactured in a comparatively simple way while realizing high precision.

As mentioned above, the present invention has been described with reference to the embodiment, but the present invention is not limited to the above-mentioned embodiment, and various modifications are obtainable. For example, in the present embodiment, the winding parts of the coil have five turns but it is not limited to this.

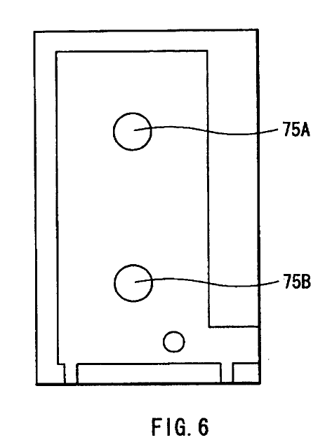

The core of the base may also be two pillar-shaped cores 75A and 75B, as shown in FIG. 6. The cores 75A, 75B are pillars which have an equivalent dimension, for example, with a diameter of 1.8 mm, and a height of 0.55 mm.

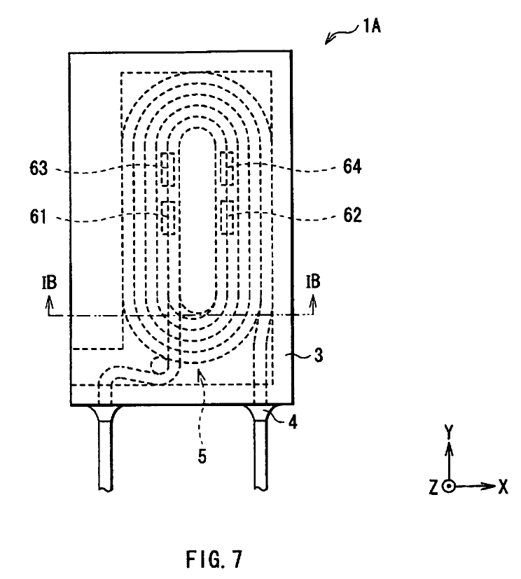

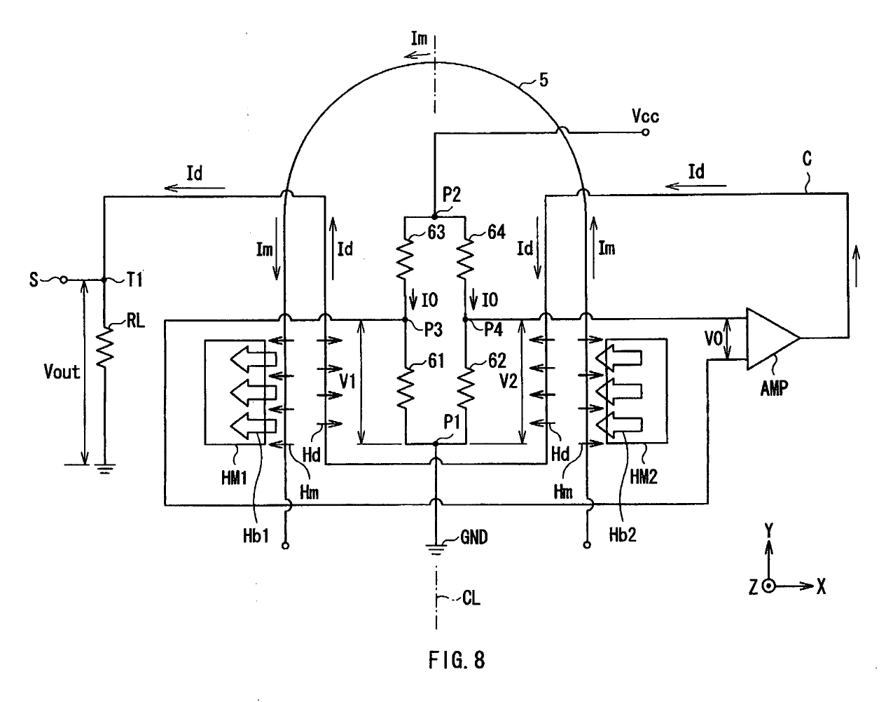

Besides, although an example is explained about the magnetic sensor formed by two GMR elements according to the above-mentioned embodiment, the present invention is not limited to this, either. For example, two more GMR elements 63 and 64 may be arranged along with the winding part 51 like a coil module 1A appearing in FIG. 7. In that case, as shown in the circuit diagram appearing in FIG. 8, the GMR elements 61-64 can form a full bridge. In this case, the magnitude of the current Im to be detected which flows into the coil 5 can be measured by applying a predetermined voltage between the first junction point P1 and the second junction point P2, and by detecting an output from the third junction point P3 and fourth junction point P4.

Although the magnetic sensor is provided on the side of the base of the housing according to the above-mentioned embodiment, the magnetic sensor may also be provided on the side of the lid of the housing. Or the magnetic sensors may be provided on both sides of the base/lid of the housing. In this manner, it is also possible to form two full bridge circuits provided so as to sandwich the coil for measuring currents to be detected with more precision.

What is claimed is:

1. A coil made of a wire comprising:
a winding section constructed of a plurality of turns of the wire, each turn having a straight-line portion and a semicircle portion; and
a lead section having a straight leader which leads a straight-line portion of an innermost turn in the winding section to outside, the straight leader extending continuously from the straight-line portion on the extension thereof,
wherein each semicircle portion is located in a layer other than a layer of the straight-line portion, climbing across the straight leader, in an area of the straight leader, while is located in a layer same as the layer of the straight-line portion, in an area other than the straight leader.

2. The coil according to claim 1, wherein the plurality of turns in the winding section are wound in such a manner that at least the straight-line portions adjacent to each other are in contact with each other.

3. A coil module comprising:
a base;
a lid; and
a coil made of a wire, the coil including: a winding section housed in a space produced when the base and the lid are combined each other, the winding section constructed of a plurality of turns of the wire, each turn having a straight-line portion and a semicircle portion; and a lead section having a straight leader which leads a straight-line portion of an innermost turn in the winding section to outside, the straight leader extending continuously from the straight-line portion on the extension thereof,
wherein each semicircle portion is located in a layer other than a layer of the straight-line portion, climbing across the straight leader, in an area of the straight leader, while is located in a layer same as the layer of the straight-line portion, in an area other than the straight leader.

4. The coil module according to claim 3, wherein the base has a recess which houses the winding section.

5. The coil module according to claim 4, wherein the recess has a depth equivalent to the diameter of the wire.

6. The coil module according to claim 4, wherein the base has a core provided inside the recess, and the coil being wound around the core.

7. The coil module according to claim 6, wherein the core includes a pair of pillars with a common diameter.

8. The coil module according to claim 3, wherein the lid has a recess provided in a position corresponding to the area where the semicircle portions climb across the straight leader.

9. The coil module according to claim 8, wherein the recess of the lid has a depth equivalent to the diameter of the wire.

10. The coil module according to claim 3, wherein the lid has one or more openings provided in an area corresponding to the winding section.

11. A current sensor comprising:
a base;
a lid;
a coil made of a wire, the coil including: a winding section housed in a space produced when the base and the lid are combined each other, the winding section constructed of a plurality of turns of the wire, each turn having a straight-line portion and a semicircle portion; and a lead section having a straight leader which leads a straight-line portion of an innermost turn in the winding section to outside, the straight leader extending continuously from the straight-line portion on the extension thereof; and
one or more magnetic sensors provided in correspondence with the straight-line portions of the winding section,
wherein each semicircle portion is located in a layer other than a layer of the straight-line portion, climbing across the straight leader, in an area of the straight leader, while is located in a layer same as the layer of the straight-line portion, in an area other than the straight leader.

12. The current sensor according to claim 11, wherein the magnetic sensors includes a pair of magnetoresistive elements provided in such a manner that resistance values of the magnetoresistive elements change in the directions opposite to each other according to the current magnetic fields generated by currents flowing through the coil.

13. A method of manufacturing a coil module, comprising:
a step of preparing a base having a pillar-shaped core and winding a wire around the core, thereby forming a coil, the coil including a winding section constructed of a plurality of turns of the wire, each turn having a straight-line portion and a semicircle portion, and a lead section having a straight leader which leads a straight-line portion of an innermost turn in the winding section to outside;
a step of putting a lid on the base so as to face each other with the coil in between; and
a step of fixing the winding section to the base with adhesives,
wherein in the step of forming the coil, the lead section is formed so as to include a straight leader extending continuously from the straight-line portion on the extension thereof; and each semicircle portion is formed in a layer other than a layer of the straight-line portion, climbing across the straight leader, in an area of the straight leader, while is located in a layer same as the layer of the straight-line portion, in an area other than the straight leader.

14. The method of manufacturing the coil module according to claim 13, wherein the lid has one or more openings provided in an area corresponding to the winding section.

15. The method of manufacturing the coil module according to claim 13, wherein the step of forming the coil is followed by steps of applying adhesives on the winding section, putting the lid on the base, and hardening the adhesives while pressing the winding section against the base through the opening, thereby fixing the winding section to the base.

16. A method of manufacturing a current sensor comprising:
a step of preparing a base having a pillar-shaped core and winding a wire around the core, thereby forming a coil, the coil including a winding section constructed of a plurality of turns of the wire, each turn having a straight-line portion and a semicircle portion, and a lead section having a straight leader which leads a straight-line portion of an innermost turn in the winding section to outside;
a step of putting a lid on the base so as to face each other with the coil in between;
a step of fixing the winding section to the base with adhesives; and
a step of providing one or more magnetic sensors in correspondence with the straight-line portions of the winding section,
wherein in the step of forming the coil, the lead section is formed so as to include a straight leader extending continuously from the straight-line portion on the extension thereof; and each semicircle portion is formed in a layer other than a layer of the straight-line portion, climbing across the straight leader, in an area of the straight leader, while is located in a layer same as the layer of the straight-line portion, in an area other than the straight leader.
